(19) United States
(12) Patent Application Publication
(10) Pub. No.: US 2002/0070915 A1
(43) Pub. Date: Jun. 13, 2002

(54) Trading system controller

(76) Inventors: Thomas A. Mazza, Wheaton, IL (US); James X. Maude, Chicago, IL (US); Theodore F. Gradel, Naperville, IL (US); Brian L. Saunders, Chicago, IL (US)

Correspondence Address: Michael P. Mazza, Niro, Scavone, Haller & Niro, Suite 4600, 181 West Madison Street, Chicago, IL, 60602, US

(21) Appl. No.: 09/733,141

(22) Filed: Dec. 8, 2000

(51) Int. Cl. G09G 5/00

(52) U.S. Cl. 345/156

(57) ABSTRACT

A preferably hand-held unit for controlling computer-implemented electronic trading operations, and permitting users, through tactile and/or audio feedback, to maintain visual contact with one or more visual displays, such as computer screens having trading-related information, without the need for continuously interrupting trading operations by focusing on the control unit or separate visual display(s) showing quantity and price terms for a particular instrument being traded.

### BACKGROUND OF THE INVENTION

The invention generally relates a controller for performing computer-implemented trading operations. More specifically, the invention relates to such a trading system controller which may be universally used in various software applications and for trading various securities and commodities, while providing more rapid and efficient trading operations.

Computerized stock and commodity exchanges such as EUREX®, GLOBEX®, NASDAQ®, LIFFE, PAWDUCT, etc., are traded through a variety of proprietary, front-end trading systems in electronic communication with the exchange and available for use by traders. Such proprietary trading systems for permitting electronic trading operations include those marketed and sold within the United States and internationally by such companies as Trading Technologies®, Yes Trader®, EZ Screens®, pat Systems®, Real Time Trading Systems® and E Speed®. Off-floor electronic trading is becoming increasingly popular. The London Exchange, for example, trades solely by this way, having abolished “on-floor” trading. While the United States is perhaps the only industrialized country left in the world which maintains the tradition of substantial “open outcry” floor trading, this tradition is not expected to continue for much longer.

proprietary trading systems used by traders for communicating with an exchange are configured to allow operators to control trading operations utilizing different hardware. Some allow control over trading operations using a conventional mouse. If a conventional mouse is used, however, electronic traders are forced to continuously shift their eyes during trading between two or more screen displays of cash instruments or other information, for example, as shown in FIGS. 6-9, on the one hand, and quantity/price selections for the particular instrument being traded, as shown in FIG. 5, on the other.

One proprietary system, the E-Speed system, provides operators with a proprietary control panel which permits controlling operations. The control panel is in the form of a rectangular box with a number (about 20) of keys which allow pricing and quantity selections. It has been found, through actual use, that operation of the E-Speed control panel requires an operator to continuously shift the focus of his vision between one or more visual displays of trading information on (e.g.) a CRT screen, and the control panel itself, since the control panel keys, buttons or levers are configured in a way that fail to provide tactile or other feedback sufficient for the trader to distinguish between the keys without actually looking at the keys.

Critical to systems that permit electronic trading is providing traders with the ability to quickly, easily and efficiently control trading operations. Speed can be paramount, since hundreds of thousands of dollars can be lost in tenths of seconds in a fast-moving market.

It is believed that all known trading systems, including those that use conventional mice as well as those that use proprietary hardware control panels such as the E-Speed control panel, require operators to constantly shift their vision either between a hardware controller and one or more visual displays having trading-related information, or between various such visual displays, each and every time a trading operation is performed. This substantially impedes the speed with which trading operations can be performed.

Accordingly, a primary object of the present invention is to provide a trading controller which permits the trader to maintain substantially uninterrupted visual contact with visual displays of trading-related information, during the performance of trading operations, and without the need to interrupt trading operations by shifting visual contact to pricing/quantity information located either on a separate visual display or on the hardware controller.

### DEFINITION OF CLAIM TERMS

The following terms are used in the claims of the patent as filed and are intended to have their broadest meaning consistent with the requirements of law. Where alternative meanings are possible, the broadest meaning is intended. All words used in the claims are intended to be used in the normal, customary usage of grammar and the English language.

“Button” means any of various control mechanisms that may be used in connection with the controller of the invention, including levers, switches, joysticks, depressable buttons, sliders, etc. As used here, the term “button” is expressly not limited to its ordinary, dictionary definition or common meaning.

“Computer” is not limited to personal computers, but is broad enough to include computers used with cell phones, palm pilots or other mobile computing and/or communication devices.

“proprietary trading applications” means proprietary trading systems, such as provided by Trading Technologies®, which permit electronic trading operations to take place between a trader and an exchange.

“Substantially constant visual contact” means that the trader is able to maintain visual contact with a selected visual display while requiring little or no interruption or shift of focus to the controller or to a non-selected visual display, such as a quantity/price screen, which the trader does not then desire to focus on, during the performance of trading operations.

“Trading operations” means control operations performed by a trader, typically involving the selection or de-selection of quantity and/or price parameters, which allow trading to take place.

### SUMMARY OF THE INVENTION

The objects mentioned above, as well as other objects, are solved by the present invention, which overcomes disadvantages of prior art electronic trading controllers while providing new advantages not believed associated with such trading controllers.

In one preferred embodiment, a control unit is provided which is in electrical communication with one or more computers for use in performing electronic trading operations. The computer(s) are in communication with at least one visual display for displaying to an operator of the control unit trading-related information. The control unit is preferably capable of being held and controlled within the hands of the user, preferably with the controller held in the hands or in the lap of the trader/operator. The control unit also includes trading control buttons allowing the operator to perform trading operations without the need for sliding the control unit over a surface, and permitting the operator to use the control unit to perform electronic trading operations while maintaining substantially constant visual contact with the visual display, and substantially without the need for visually focusing on the control unit during the performance of trading operations. The control unit may also include a cursor control mechanism for allowing the operator to position a cursor within the at least one visual display. The control unit also includes customizable software enabling the controller to interface with a variety of proprietary trading applications.

In a preferred embodiment, the operator is able to maintain the control unit within a hand held position during trading operations. e control unit of claim 1, wherein the trading control buttons have different shapes, sizes or textures to provide the operator with tactile feedback sufficient to allow the operator to distinguish between the trading control buttons without first visually focusing on the buttons.

In one preferred embodiment, the trading control buttons emit different audible signals to allow the operator to distinguish between the trading control buttons without first visually focusing on the buttons. In alternative embodiments, the control unit may include a visual display, such as an LED screen displaying trading-related information. The control unit may also include a lever, for example, permitting the vertical scrolling of information on a visual display. The control unit may also include a button, such as a “shift” key which, when depressed, changes the function of other buttons located on the control unit.

Two or more visual displays may be used by the trader, with each of the displays potentially being in electrical communication with the one or more computers. In this embodiment, the control unit may include a transfer mechanism which allows the operator to shift cursor control between the two or more visual displays.

In one preferred embodiment, the control unit employs software configured to mimic mouse/keyboard input, such as a virtual plate of glass which may be placed over the user interface for a proprietary application. preferably, the control unit employs software capable of interfacing with a variety of proprietary trading applications.

A method for using a control unit made according to the principles of the present invention is also disclosed and claimed. In one preferred embodiment, a method is provided for using a control unit in electrical communication with one or more computers for performing electronic trading operations, the one or more computers communicating with at least one visual display for displaying to an operator of the control unit trading-related information. In the preferred embodiment of the method, trading operations are performed using trading control buttons located on the control unit. These trading operations are performed without the need for positioning the control unit on a surface or sliding the control unit over a surface. This allows the operator to use the control unit to perform electronic trading operations while maintaining substantially constant visual contact with the visual display and substantially without the need for visually focusing on the control unit during operation. These trading operations are preferably, though not necessarily, performed while maintaining the control unit within a hand-held position.

### BRIEF DESCRIPTION OF THE DRAWINGS

The novel features which are characteristic of the invention are set forth in the appended claims. The invention itself however, together with further objects and attendant advantages thereof, will be best understood by reference to the following description taken in connection with the accompanying drawings, in which:

FIG. 1 is a perspective view of a seated operator holding in his lap a preferred trading controller of the present invention for performing trading operations;

FIGS. 2 and 3 are side and top perspective views of the preferred trading controller of the present invention;

FIG. 4 is a schematic block diagram illustrating, in apreferred embodiment, the software components for the controller;

FIG. 5 is a sample visual display on, e.g., a computer screen informing the trader of quantity, price and other parameters necessary for the performance of trading operations; and

FIGS. 6-9 are sample visual displays illustrating the types of detailed information a trader might be analyzing during an ongoing trading operation.

### DETAILED DESCRIPTION OF THE PREFERRED EMBODIMENTS

Set forth below is a description of what are currently believed to be the preferred embodiments and/or best examples of the invention claimed. Future and present alternatives and modifications to these preferred embodiments are contemplated. Any alternatives or modifications which make insubstantial changes in function, in purpose, in structure or in result are intended to be covered by the claims of this patent.

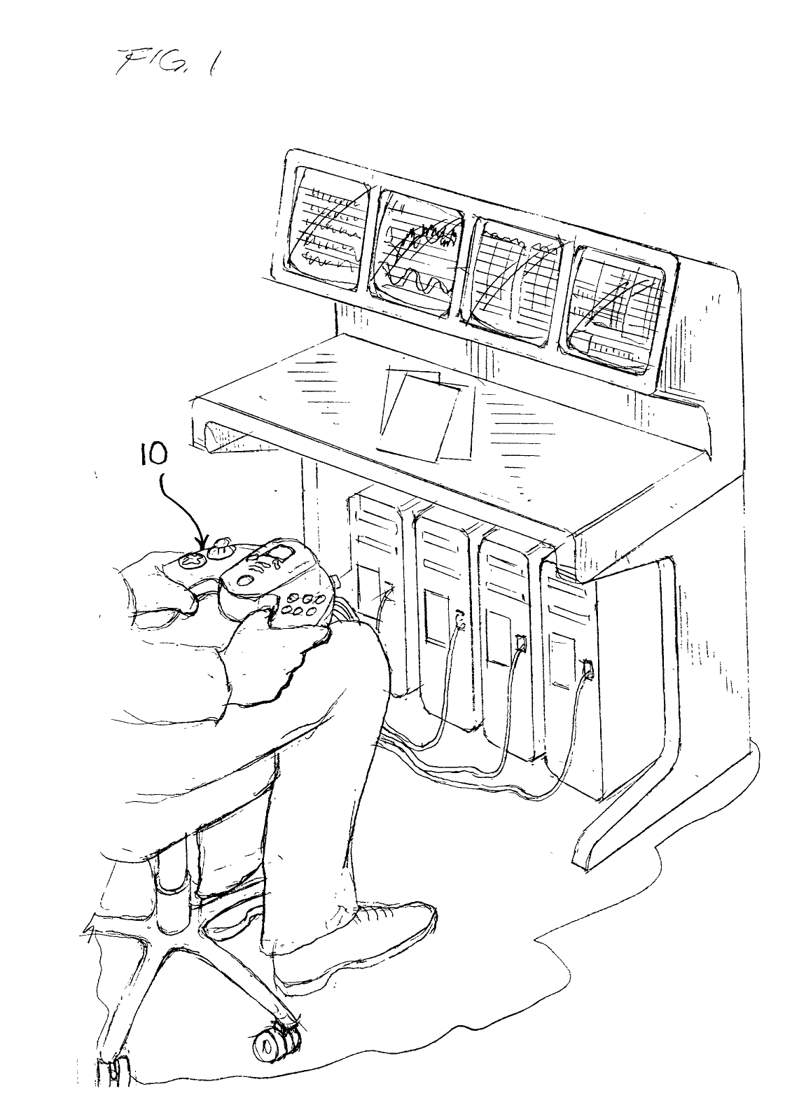

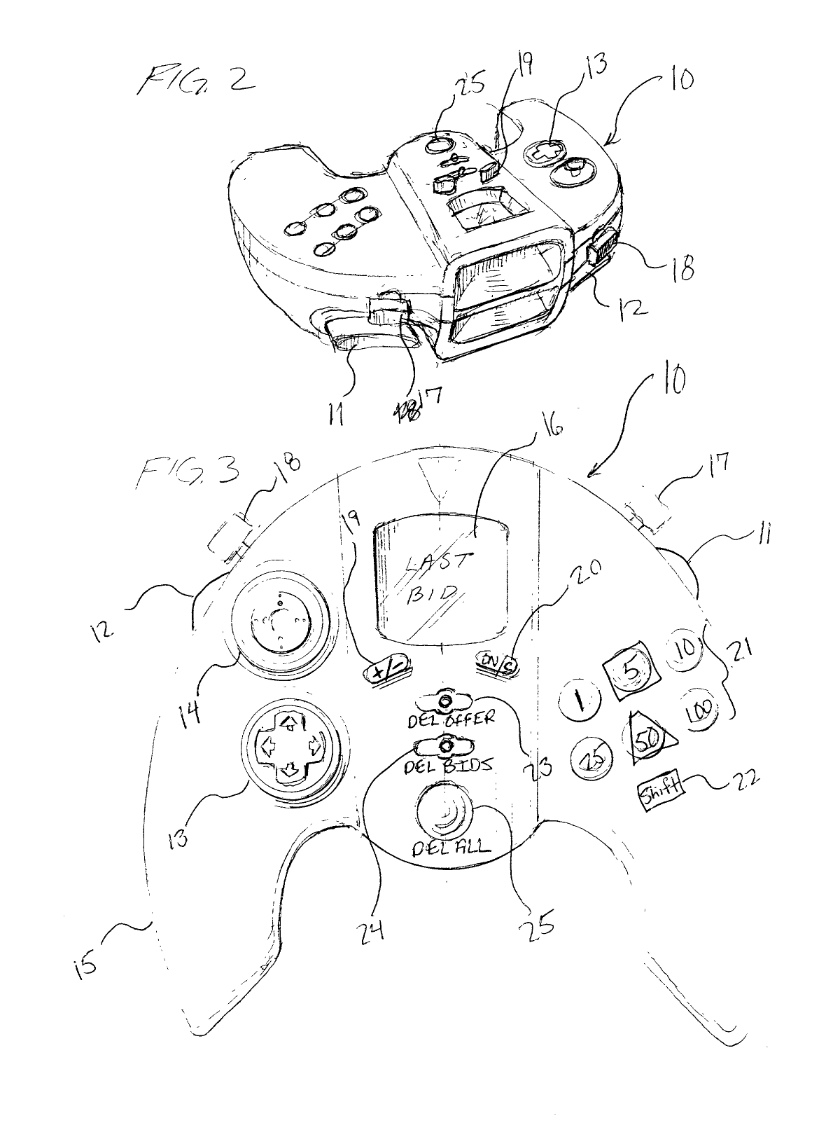

The manner of controlling trading operations using the trading controller of the present invention is now described with regard to the drawings. Referring to FIGS. 1-3, a preferred embodiment of the trading controller 10 of the present invention is shown. Control unit or controller 10 is easily held in the lap or, alternatively, on a desk, table or other surface, as shown in FIG. 1. Controller 10 may include the following keys, buttons or levers: 13 (e.g., for moving between different windows) and 14 (e.g., for cursor control); 11, 12 (buy and sell buttons, respectively); 16 (LED display for showing, e.g., trading position, date, time, etc.); 17, 18 (cancel/delete buy and sell button functions, respectively); 19 (moving price or “tick” up or down); 20 (“clearing” selected quantity back to zero) ; 21 (quantity buttons); and 22 (“shift” or second function key, as further explained below).

Controller housing 15 is preferably sized and shaped so that it may be easily and conveniently controlled with the hands while located in the trader's lap or on a desk, table or other surface, as further explained below.

Quantity buttons 21 are preferably sized and shaped so as to provide tactile feedback to the user, to allow the user to select a particular quantity button without the need for the user to glance down at the controller. For example, different shapes may be provided for quantity buttons 21, as shown in FIG. 3. Further, the quantity buttons may be provided in a “stepped” or graduated-scale configuration so that they differ in height in a tactile detectable sense. To further facilitate this, quantity buttons may be provided with means for audible sounds, e.g., stating “50” when the 50-lot button has been actuated, using any expedient software as is well known in the art.

The trading controller software is designed to allow a fast-access “game controller” interface with any windows-based “proprietary” application. While the initial controller is envisioned specifically for the trading community, and there are a limited number of proprietary applications which the specific embodiment of controller 10 as disclosed in the drawings is currently intended to interface with, it will be understood that the general principles of the invention provided here will enable programmers with ordinary skill in the art to interface controller 10 with a variety of other applications, as well, as further discussed below.

The trading controller software allows controller 10 to “talk to” proprietary applications using two alternatives. In a first alternative, the software be used as a replacement or supplement for traditional mouse and keyboard input. In this embodiment, controller 10 is actually configured to mimic mouse/keyboard input. In a preferred embodiment, this may be accomplished by placing a virtual “plate of glass” over the user interface for a proprietary application, as is performed by software testing applications such as those produced by Rational Software or Mercury Interactive. When the trading device signals the need for mouse/keyboard input, the software sends “signals” to the proprietary application through standard windows APIs which direct mouse/keyboard input. This “plate of glass” approach requires each proprietary application to be “configured” to specific controls/buttons on controller 10. That configuration may be accomplished using a Configuration Engine component (a standard windows-based program). In addition, in order to minimize work to the user, these configurations may be saved into configuration files. Then, those files may be shipped with the controller hardware and may be “selected” so that controller 10 may be automatically configured to work with several popular trading packages “out of the box.”

Alternatively, a second interface to controller 10 may be provided through a public API. With this embodiment, the interface actually allows the creators of proprietary trading packages to custom code their applications to take advantage of the controller. In a preferred embodiment, the system sends API messages to the proprietary software, and the software manufacturer codes events which listen for those messages. Since the API is public, software vendors may code their systems to use the controller without requiring programming assistance. The API interface also allows the system to provide feedback to the user via the controller so that tactile confirmation of trades executed or cancelled (for example) may be provided.

In a preferred embodiment, the trading controller software interfaces with controller 10 which communicates via a serial port. The software is a separate “loadable” module which installs when the controller is installed and which is assigned to a specific port at the time of installation. The module loads like any peripheral device, and it does not require the replacement of the standard keyboard/mouse interface.

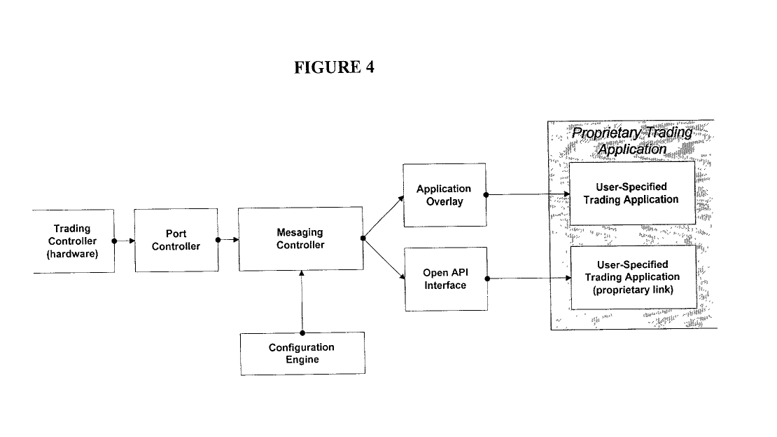

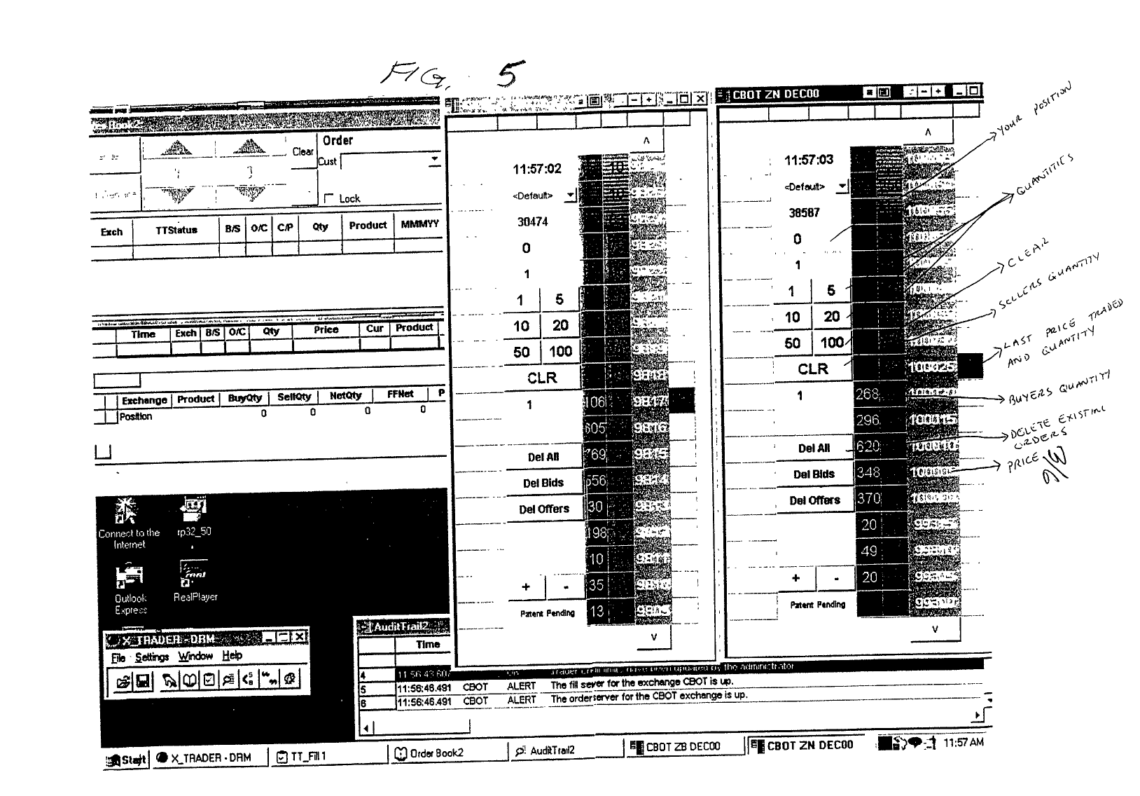

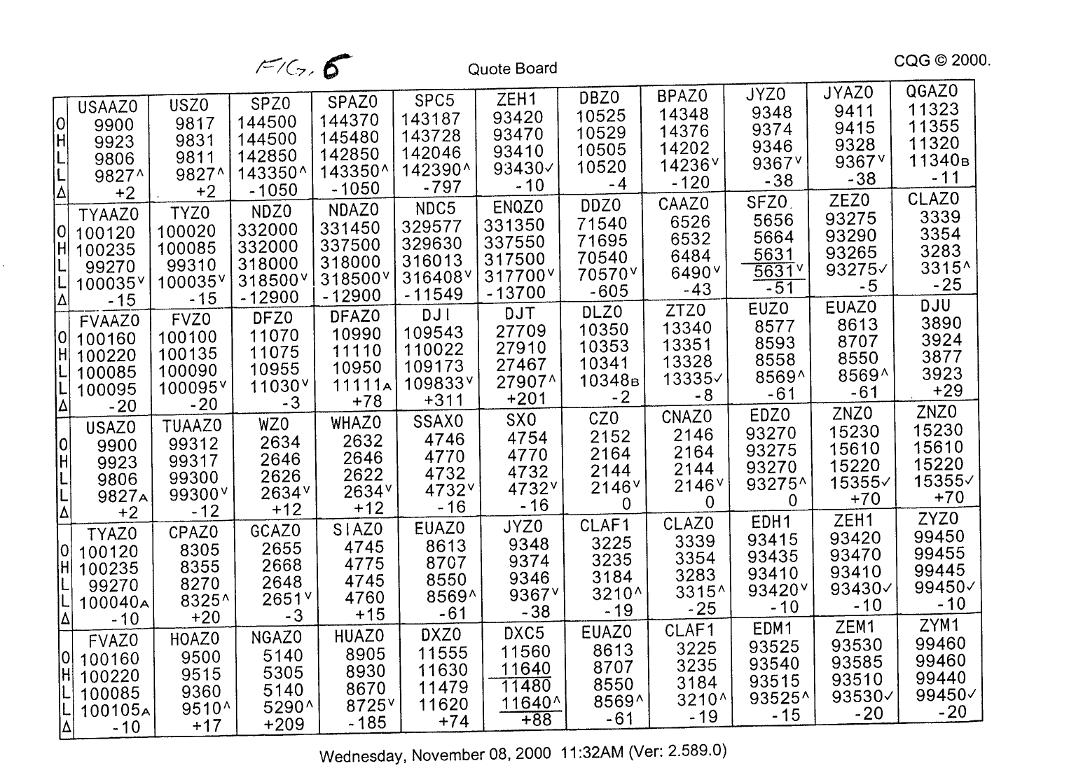

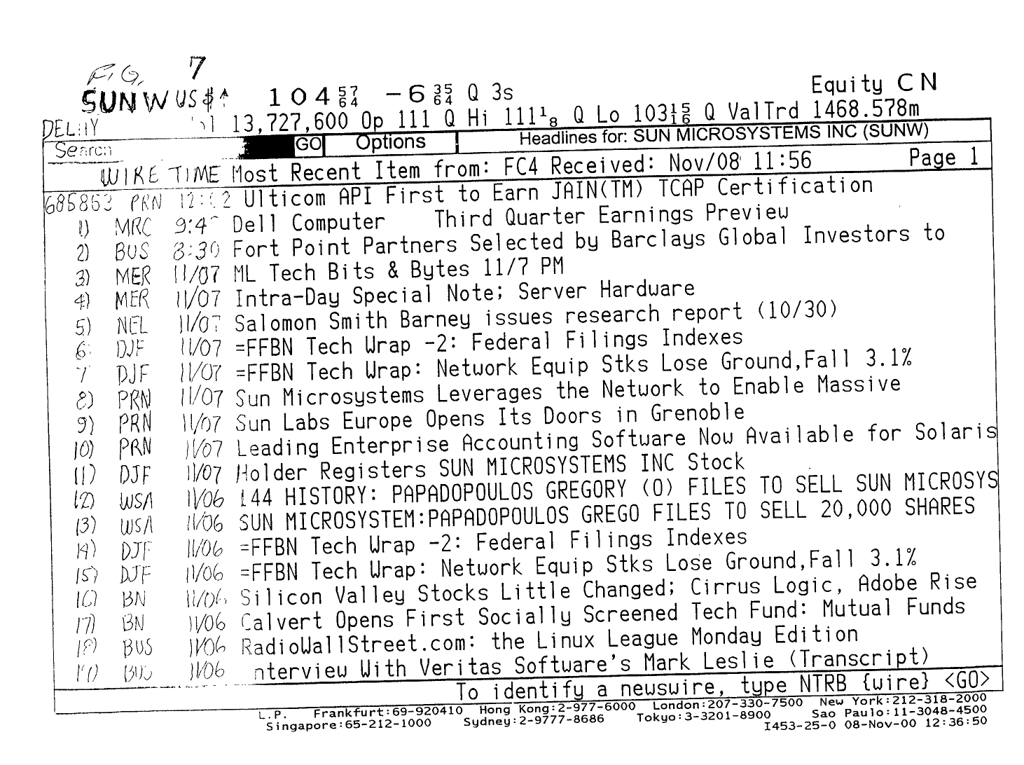

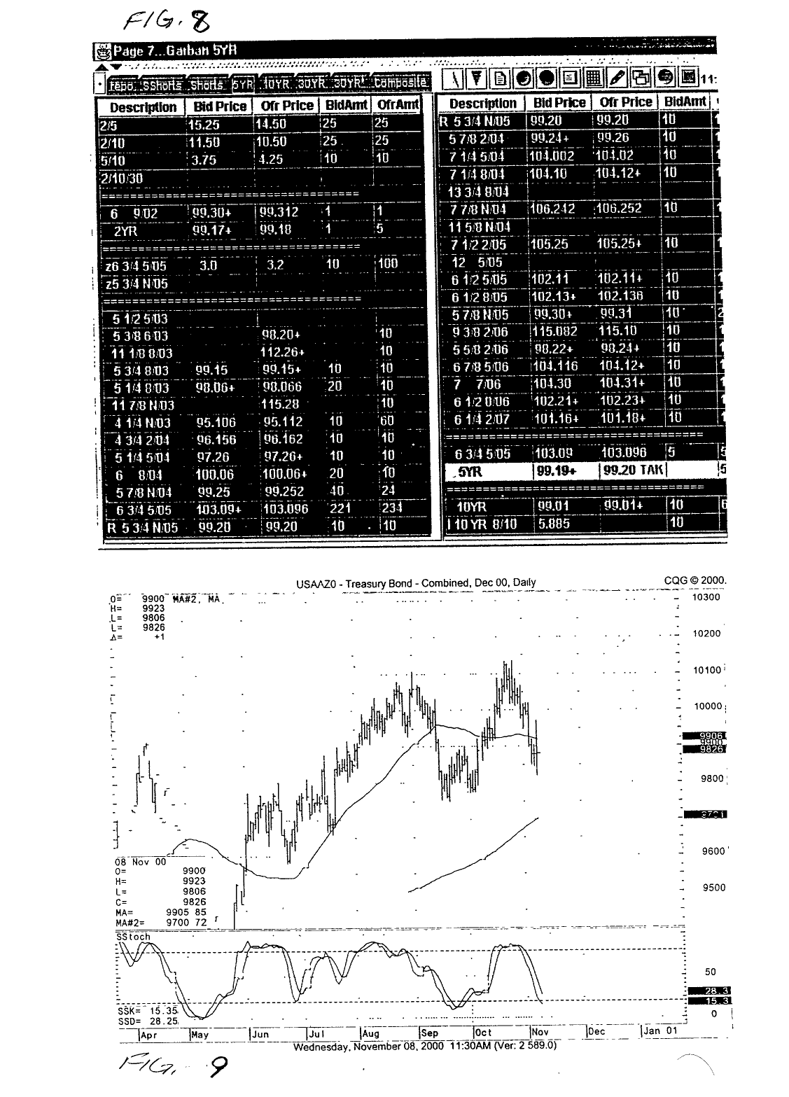

In the preferred embodiment, trading controller 10 is intended as a supplemental or alternative device and is intended to replace keyboard/mouse input for trading applications. (Other specific applications which require very quick entry and response times may also be employed with controller 10, of course.) The software may be installed and then “configured” to work with a specific application. In one preferred form, the software's components are outlined in FIG. 4. The components shown in FIG. 4 are briefly described below:

Trading Controller (hardware): This is the actual physical controller (plugged into a serial port on any standard PC).

port Controller: The port controller listens for input from the physical controller. Each “button click” is read by the controller and then passed to the message controller in real time. Combinations (e.g.—“shift”+“button A”) are translated in the port controller and passed through to messaging controller for processing as well. Use of the “shift” key thus provides the controller with enhanced flexibility by potentially converting each button into a two-function control. The port controller utilizes Microsoft's DirectInput standard to communicate with the actual Trading Controller hardware.

Messaging Controller: This is the program's primary controller. The messaging controller actually processes input from the physical device. When input is received, this controller (1) stores the input (in the case of multi-part messages); (2) converts the message received from the port controller into either mouse/keyboard input or API commands; (3) issues a “green light” to either the Application Overlay or to the API in order to actually control the proprietary system (e.g. —when the user clicks the “500 lot” button, the messaging controller sends a message to the Application Overlay which “clicks” the “500 lot” button on the proprietary trading system).

Application Overlay: This component is a “sheet of glass” which lays on top of the user interface for any windows-based application and which mimics keyboard/mouse input. This simple component is the program element which enables this system to integrate with any windows-based application without any code.

Open API Interface: In addition to the Application Overlay, the program can communicate to the proprietary Application at a more integrated level. This API enables an integrated program to communicate directly with the device and bypass the proprietary Application's user “screen” interface. The API is an open, published, standard which enables outside software vendors to create “code” which can listen to the device and program a much faster and more “customized” response to the device's input.

Configuration Engine: In most situations, the user will need to map the buttons to the device to specific regions within the proprietary application they are interacting with. The configuration engine is the program which will enable the user to walk through that configuration. In many instances, the device will come with a “pre-installed” set of configuration options which can be pre-selected. In this way, the device is integrated with popular trading applications “out of the box.”

In a preferred embodiment, the trading system of the present invention interacts with controller 10 using the Microsoft DirectInput standard, in which case controller 10 is built with a circuit which supports the DirectInput standard. Depending on the trading transaction, several “button clicks” of controller 10 may be required. Preferably, the controller software interprets each individual click and provides a “reset” capability if a transaction is cancelled mid-sequence. Controller 10 may be provided with a “reset” button which is used to: (1) verify that the proprietary system is online; (2) arrange the various windows used by the proprietary system correctly on screen (if the Application Overlay approach is being used); and (3) verify that the proprietary system “focus” is set correctly. This reset button may also be used to re-align the “plate of glass” if the user has interrupted the game controller use and returned to standard mouse/keyboard input.

The Server operating system may be supported, for example, by Windows 9X (95/98) or Windows NT (version 4 or higher, service pack 4 or higher). Other support systems, such as Windows 2000 or Unix, for example, may be used with suitably different operating systems, which alternative systems are also envisioned for use with the present invention.

The proprietary systems used with controller 10 are preferably based on standard windows systems and respond to the standard windows API calls for keyboard and mouse input. Those systems, such as Trading Technologies and Yes Trader, which are fully windows compliant are easiest to integrate.

It has been found in practice that a seated trader with controller 10 in his lap, for example, can perform trading operations more rapidly than using other known trading controllers, such as conventional mice or the E Speed® unit and while maintaining substantially constant visual contact with at least one visual display showing trading-related information. It will now be understood that users of controller 10 will be able to perform trading operations substantially without the need for visually focusing on control unit 10 during operation. It will now be understood, for example, that use of controller 10 makes it unnecessary to consult screens showing quantity/price terms during the performance of trading operations, since such terms may be selected by the trader through tactile and/or audible feedback, as has been demonstrated, and without the need for the trader to visually focus on the controller.

The above description is not intended to limit the meaning of the words used in the following claims that define the invention. For example, it will be understood that other forms of a controller than those specifically shown and mentioned here that accomplish the same general operations may do so in insubstantially different ways, while still permitting trading operations to be controlled within the principles of the present invention. As one non-limiting example, non-visual controllers such as “wearable PCs” or retinal-controlled computers, might be designed in a manner that permits trading operations to take place within the principles of the present invention. Thus, it is contemplated that future modifications in structure, function or result to the trading controllers specifically disclosed here will exist that are not substantial changes and that all such insubstantial changes in what is claimed are intended to be covered by the claims.

We claim:

1. A control unit in electrical communication with one or more computers for use in performing electronic trading operations, the one or more computers communicating with at least one visual display for displaying to an operator of the control unit trading-related information, comprising:
trading control buttons allowing the operator to perform trading operations without the need for the need for sliding the control unit over a surface and permitting the operator to maintain substantially constant visual contact with the at least one visual display, substantially without the need for visually focusing on the control unit during the performance of trading operations; and
customizable software enabling the controller to interface with a variety of proprietary trading applications.

2. The control unit of claim 1, wherein the control unit includes a cursor control mechanism for allowing the operator to position a cursor within the at least one visual display.

3. The control unit of claim 1, wherein the trading control buttons have different shapes, sizes or textures to provide the operator with tactile feedback sufficient to allow the operator to distinguish between the trading control buttons without visually focusing on the buttons.

4. The control unit of claim 1, wherein the trading control buttons emit different audible signals to allow the operator to distinguish between the trading control buttons without visually contacting on the buttons.

5. The control unit of claim 1, wherein the control unit includes a visual display.

6. The control unit of claim 5, wherein the visual display comprises an LED screen showing trading-related information.

7. The control unit of claim 1, further comprising two or more visual displays in electrical communication with the one or more computers, wherein the control unit includes a transfer mechanism allowing the operator to shift cursor control between the two or more visual displays.

8. The control unit of claim 1, wherein the control unit includes a button allowing the vertical scrolling of information on a visual display.

9. The control unit of claim 1, wherein the control unit includes a button which, when depressed, changes the function of other buttons located on the control unit.

10. The control unit of claim 1, wherein the control unit employs software configured to mimic mouse/keyboard input.

11. The control unit of claim 10, wherein a virtual plate of glass is placed over the user interface for a proprietary application.

12. The control unit of claim 1, wherein the control unit is sized to permit it to be hand-held during the performance of trading operations.

13. A method for using a control unit in electrical communication with one or more computers for performing electronic trading operations, the one or more computers communicating with at least one visual display for displaying to an operator of the control unit trading-related information, comprising the steps of:
performing trading operations using trading control buttons located on the control unit without the need for sliding the control unit over a surface and permitting the operator to maintain substantially constant visual contact with the at least one visual display, substantially without the need for visually focusing on the control unit during the performance of trading operations.

14. The method of claim 13, wherein trading operations are performed while maintaining the control unit within a hand-held position.
